(19) United States
(12) Patent Application Publication
(10) Pub. No.: US 2026/0087392 A1
(43) Pub. Date: Mar. 26, 2026

(54) QUANTUM COMPUTING ARRANGEMENT AND QUANTUM COMPUTER

(71) Applicant: eleQtron GmbH, Siegen (DE)

(72) Inventors: Michael Johanning, Siegen (DE); Sebastian Bock, Berlin (DE); Pedram Yaghoubi, Siegen (DE); Patrick Huber, Herdorf (DE); Patrick Barthel, Burbach (DE); Christof Wunderlich, Siegen (DE); Theeraphot Sriarunothai, Siegen (DE); Hendrik Siebeneich, Siegen (DE); Florian Köppen, Siegen (DE)

(21) Appl. No.: 19/112,552

(22) PCT Filed: Sep. 26, 2023
(86) PCT No.: PCT/EP2023/076526

§ 371 Date: Mar. 17, 2025

(30) Foreign Application Priority Data
Sep. 26, 2022 (DE) 10 2022 124 692.2

(51) Int. Cl. G06N 10/40; G06N 10/60

(52) U.S. Cl. CPC G06N 10/40; G06N 10/60

(57) ABSTRACT

In an embodiment a quantum computing arrangement includes a permanent magnet arrangement configured to establish a magnetic field with magnitudes being different from one another for different positions on a first axis, and an ion trap having a first region and a second region arranged above one another, wherein the ion trap has at least one section being part of the first region and the second region configured for hosting at least one ion crystal, wherein the first and second regions are stacked above one another in a vertical direction, wherein the vertical direction is perpendicular to a main extension plane of the ion trap, and wherein the at least one ion crystal includes a plurality of trapped ions arranged along the first axis.

### CROSS-REFERENCE TO RELATED APPLICATIONS

This patent application is a national phase filing under section 371 of PCT/EP2023/076526, filed Sep. 26, 2023, which claims the priority of German patent application no. 102022124692.2, filed Sep. 26, 2022, each of which is incorporated herein by reference in its entirety.

### TECHNICAL FIELD

The present disclosure relates to a quantum computing arrangement and a quantum computer.

### BACKGROUND

Exemplarily, ion traps are configured to trap and manipulate ions in order to use them for quantum computing processes, i.e. in order to perform calculations. For charged trapped ions, an interaction as e.g. Coulomb repulsion creates a coupling of neighbouring trapped ions and enables entanglement. Thus, in order to perform quantum computing processes using the trapped ions, the trapped ions have to be controllable and addressable individually from one another.

An individual addressing of a plurality of trapped ions, e.g. a quantum bit register, is desirable with negligible crosstalk. However, a crosstalk between neighbouring trapped ions is typically a difficult source of error to control in quantum computer processes and can prevent a meaningful application of quantum error correction protocols and thus a scalability.

### SUMMARY

Embodiments provide a quantum computing arrangement having an improved controllability. Further embodiments provide a quantum computer comprising such a quantum computing arrangement.

According to at least one embodiment, the quantum computing arrangement comprises a permanent magnet arrangement configured to establish a magnetic field with magnitudes being different from one another for different positions on a first axis. Exemplarily, the magnitude of the magnetic field changes along the first axis for different positions on the first axis.

The permanent magnet arrangement has a main extension plane, wherein the first axis extends along the main extension plane. “Extending along the main extension plane” can mean here and in the following that the first axis extends within the main extension plane or parallel to the main extension plane.

The first axis is a virtual axis. For example, the first axis is an axisymmetric axis of the permanent magnet arrangement extending within the main extension plane. This is to say that the first axis splits the permanent magnet arrangement in cross-sectional view along the main extension plane in two halves and a shape of the two halves is essentially identical. “Essentially identical” means exemplarily that, due to manufacturing tolerances of the permanent magnet arrangement, the halves, e.g. an area of the cross sections of the halves, can differ at most by 5% or at most by 1% to one another. Alternatively, the first axis has a distance to the axisymmetric axis of the permanent magnet arrangement.

The permanent magnet arrangement is configured to generate a magnetic multipole field. In particular, a magnetic quadrupole field is generated at a centre of the permanent magnet arrangement, the magnitude of the magnetic field is vanishing, e.g. is approximately o T. Due to the magnetic multipole field, particularly due to the magnetic quadrupole field, the magnitudes of the magnetic field are different for different positions on the first axis.

For such a permanent magnet arrangement, the magnitude of the magnetic field changes continuously along the first axis, i.e. for different positions on the first axis starting from the centre. Thus, the magnitudes of the magnetic field for different positions on the first axis are characteristic for a magnetic field gradient along the first axis.

The magnetic field is represented by a magnetic flux density. Further, an absolute value of the magnetic flux density corresponds to the magnitude of the magnetic field for a predetermined position on the first axis.

Components of the magnetic field correspond to components of vectors, wherein the vectors can point in any direction with respect to the first axis. This is to say that at least some of the vectors of the magnetic field for different positions on the first axis can have different angles with respect to the first axis. For example, at least some of the vectors of the magnetic field point in radial direction of the first axis or in axial direction of the first axis.

For example, at least some of the vectors of the magnetic field point in the same radial direction and/or in the same axial direction of the first axis for different positions on the first axis. Alternatively or additionally, at least some of the vectors of the magnetic field are rotated in radial direction of the first axis with respect to one another.

A distribution of the magnitude of the magnetic field is symmetrical with respect to the centre of the permanent magnet arrangement along the first axis. Exemplarily, the first axis is split into two halves by the centre of the permanent magnet arrangement, i.e. by a virtual line, perpendicular to the first axis, cutting the first axis into the two halves. The magnitude of the magnetic field has a negative slope for one half and a positive slope for the other half. The magnetic field gradient grows along the first axis, with respect to the magnitude of the magnetic field along the first axis, is, for example, approximately linearly. This is to say that the magnetic field gradient is approximately constant along the first axis starting from the centre. Deviations of at most 5% from the linearity can be present due to production tolerances of the permanent magnet arrangement, exemplarily, within the centre region.

According to at least one embodiment, the quantum computing arrangement comprises an ion trap having a first region and a second region arranged above one another. Exemplary, the first region extends along a first level and the second region extends along a second level. For example, the ion trap has a further main extension plane. The first level and the second level each extend parallel to the further main extension plane.

Lateral directions are defined parallel to the further main extension plane and a vertical direction is defined as being vertical to the further main extension plane. The first level and the second level are stacked above one another in vertical direction.

The first region and the second region comprise components being configured to trap ions with a predetermined trap potential. The trap potential can be static or dynamic. For example, ions to be trapped are trapped by electromagnetic fields, particularly by radio frequency fields for charged trapped ions.

According to at least one embodiment of the quantum computing arrangement, the ion trap has at least one section being part of the first region and the second region for hosting at least one ion crystal. The at least one ion crystal comprises a plurality of trapped ions arranged along the first axis. This is to say that one ion crystal is characteristic for one quantum register comprising a plurality of trapped ions.

One ion crystal can comprise or consist of more than two, e.g. at least 8, at least 20 or at least 100 and/or at most 1000, trapped ions. Each trapped ion is a quantum bit, qubit for short.

If the ion trap has more than two sections, the ion trap can host more than two ion crystals. Each section is configured to host one of the ion crystals. The sections do not overlap with one another in lateral directions. All sections are part of the first region and the second region. This is to say that the sections are configured to segment the first region and the second region.

For example, each trapped ion is represented by a two-level quantum system. If no magnetic field is applied to a two-level quantum system, the two-level quantum system comprises a first level and a second level, wherein both levels correspond to a respective eigenstate of the respective trapped ion. For example, the first level represents a ground state of the respective trapped ion and the second level represents an excited state of the respective trapped ion.

Exemplarily, due to the magnetic field being provided to the two-level quantum system, a degeneracy of the second level is lifted such that at least two, in particular at least three, sub-levels are generated. This results in two, in particular three, possible transitions from each of the two, in particular three, sub-levels to the first level.

If the trapped ions are n-level quantum systems, wherein n is a natural number equal or bigger than two, each n-level quantum system comprise n levels. For example, at least some of the n-levels correspond to a sub-level, when the magnetic field is applied. In such an n-level quantum system, a plurality of transitions is achievable.

For the trapped ions, the magnitudes of the magnetic field are different for different positions on the first axis and thus, the splitting, depending on the local magnetic field magnitude, is also different for these trapped ions. Therefore, a frequency difference of a specific transition between neighbouring trapped ions is also achieved. Due to the frequency differences different resonance frequencies for the neighbouring trapped ions also result.

A total energy of each of the trapped ions is predetermined by the trap potential and the energy characteristic for the respective transition depending on the magnitude of the magnetic field.

It is an idea, inter alia, to use the permanent magnet arrangement in combination with the ion trap. Due to the different magnitudes of the magnetic field, i.e. the magnetic field gradient of the permanent magnet arrangement, the trapped ions can be addressed individually in frequency space such that an improved multi-quantum bit gate can be advantageously implemented and a coupling of neighbouring trapped ions can be controlled. Furthermore, by adjusting the coupling, highly entangled cluster states can be generated to be advantageously used for quantum computation.

Advantageously, permanent magnets exhibit a comparatively low noise in comparison with an electromagnet, and thus allows for high fidelity control of the trapped ions.

In sum, a permanent magnet arrangement is used for obtaining large magnetic field gradients experienced by ions trapped in a planar or surface ion trap to create largely different magnetic fields seen by the ions storing a spin qubit each. Using this for quantum information processing this allows for advanced addressing in frequency space and thus individual single qubit rotations with low cross-talk, and introduces an effective coupling between the ions, thus enabling multi-qubit gates. This can also be used in connection with radio frequencies, RF, for which addressing by focusing radiation is not an option due to the long wavelength, but the usage of RF fields for qubit control allows for the application of established and economic miniaturization and integration techniques already common even in consumer electronics, and simplifies scaling an ion trap based quantum computer. The steepness of the magnetic field gradient might be further enhanced by using yokes to concentrate the magnetic flux. The permanent magnet arrangement, which is in particular a Halbach arrangement, allows for large magnetic field gradients even when a distance between any surface, including main surfaces of trap electrodes and magnets, and trapped ions should be large which is desirable for high fidelity gates with trapped ions. This combined with segmented ion traps, as described herein, allows for flexible trapping configurations, to trap several registers, for splitting and merging of quantum registers, tuning of coupling constant between qubits and in general for scaling the power of ion trap based quantum computers.

According to at least one embodiment of the quantum computing arrangement, the first region and the second region each comprise at least two end cap electrodes arranged at respective end regions of the ion trap. For example, the ion trap has a first end region and a second end region. The first end region and the second end region are located at opposite end faces of the ion trap.

For example, the first region has a first end cap electrode in the first end region and a second end cap electrode in the second end region, between which the at least one section is located. Further, the second region has a first end cap electrode in the first end region and a second end cap electrode in the second end region. In this case, the first end cap electrode of the first region and the first end cap electrode of the second region overlap with one another in lateral directions, in particular congruently. In this case, the first end cap electrode of the first region and the first end cap electrode of the second region have the same dimensions and are stacked above one another.

Further, the second end cap electrode of the first region and the second end cap electrode of the second region overlap with one another in lateral directions, in particular congruently. In this case, the second end cap electrode of the first region and the second end cap electrode of the second region have the same dimensions and are stacked above one another.

Exemplarily, the first end cap electrode of the first region and/or the first end cap electrode of the second region comprise two parts. The two parts of the first region and/or the two parts of the second region are spaced apart from one another in lateral directions, in particular perpendicular to the first axis. Similarly, the second end cap electrode of the first region and/or the second end cap electrode of the second region comprise two further parts. The two further parts of the first region and/or the two further parts of the second region are spaced apart from one another in lateral directions, in particular perpendicular to the first axis.

The first end cap electrode and the second end cap electrode are each configured to be supplied with a direct current, dc for short. The first end cap electrode and the second end cap electrode are configured to trap the to-be-trapped ions along the first axis.

Exemplarily, at least one section is arranged between the first end cap electrode and the second end cap electrode. If the ion trap comprises more than one section, further cap electrodes, in particular comprising a first separating cap electrode and a second separating cap electrode in each of the first region and the second region, are arranged between directly neighbouring sections in the first region and the second region, for example. This is to say that the further cap electrodes are configured to directly separate neighbouring sections from one another in lateral directions, exemplary in axial direction. Further, the further cap electrodes are configured to trap the to-be-trapped ions of each section, in particular the ion crystal, along the first axis.

Dimensions and properties described herein above according to the first end cap electrodes and the second end cap electrodes can also be applicable for the first separating cap electrodes and the second separating cap electrodes, respectively, arranged between directly neighbouring sections.

In particular, having the first separating cap electrodes and the second separating cap electrodes directly separating neighbouring sections, a coupling of directly neighbouring ion crystals can be achieved by a predetermined dc current provided to the first separating cap electrodes and the second separating cap electrodes. This is to say that a potential barrier between directly neighbouring ion crystals along the first axis can be predetermined by the first separating cap electrodes and the second separating cap electrodes.

Advantageously, due to such a coupling of neighbouring ion crystals, computing processes can be enabled in comparison to a quantum computing arrangement where the ion crystals are not coupled.

According to at least one embodiment of the quantum computing arrangement, the at least one section comprises a first radio frequency, rf, electrode and a first direct current, de, electrode in the first region and a second rf electrode and a second dc electrode in the second region. The first rf electrode, the second rf electrode, the first dc electrode and the second dc electrode each have a main extension plane being parallel to the further main extension planes of the first region and the second region. In particular, the main extension planes of the first rf electrode, the second rf electrode, the first dc electrode and the second dc electrode are parallel to one another.

The rf electrodes are each configured to be supplied with an alternating current, having a frequency range ranging from 200 kHz to 30 GHz. For example, a direct current can be superimposed with the alternating current. The dc electrodes are each configured to be supplied with a direct current. For example, the direct current can be superimposed with an alternating current.

It is also possible that the dc electrodes are replaced by rf electrodes. However, in each case, the rf electrodes and the dc electrodes of the first region and the second region of one section are configured to trap the to-be-trapped ions perpendicular to the first axis.

In particular, the first rf electrode, the second rf electrode, the first dc electrode and the second dc electrode are configured to generate the predetermined trap potential.

According to at least one embodiment of the quantum computing arrangement, the first rf electrode and the first dc electrode are spaced apart from one another perpendicular to the first axis and the second rf electrode and the second dc electrode are spaced apart from one another perpendicular to the first axis. A distance of the first rf electrode and the first dc electrode equals, for example, a distance of the second rf electrode and the second dc electrode.

According to at least one embodiment of the quantum computing arrangement, the first rf electrode is arranged above the second dc electrode, and the first dc electrode is arranged above the second rf electrode. For example, the first rf electrode and the second dc electrode overlap with one another in lateral directions, in particular congruently. The first dc electrode and the second rf electrode, for example, overlap with one another in lateral directions, in particular congruently. Overlapping with one another in lateral directions congruently means here and in the following that the respective electrodes overlap in top view along the vertical direction with one another.

For example, the ion crystal, i.e. the trapped ions, are located in vertical direction between the first region and the second region, in particular between the first rf electrode as well as the first dc electrode and the second rf electrode as well as the second dc electrode. The ion crystal, i.e. the trapped ions, are located in lateral directions between the first rf electrode and the first dc electrode, as well as between the second rf electrode and the second dc electrode, i.e. along the first axis.

According to at least one embodiment of the quantum computing arrangement, the first dc electrode, the second dc electrode, the first rf electrode and the second rf electrode are each formed as a metallic film. Exemplarily, the metallic film comprises gold.

According to at least one embodiment of the quantum computing arrangement, the metallic film has a thickness of at most 30 μm. The metallic film has, for example, a thickness in vertical direction of at most 10 μm, at most 5 μm or at most 1 μm.

According to at least one embodiment of the quantum computing arrangement, an intermediate region is arranged between the first region and the second region. The intermediate region has a main extension plane extending in lateral directions, i.e. being parallel to the further main extension plane of the ion trap.

For example, the intermediate region is configured to space apart the first region and the second region in vertical direction. For example, the intermediate region has a thickness in vertical direction of at least 1 μm and at most 500 μm. Exemplary, the intermediate region has a thickness in vertical direction of approximately 125 μm.

According to at least one embodiment of the quantum computing arrangement, the intermediate region comprises an electrically insulating substrate for the first dc electrode, the second dc electrode, the first rf electrode and the second rf electrode. Exemplarily, the first rf electrode and the first dc electrode are provided on a first main surface of the electrically insulating substrate and the second rf electrode and the second dc electrode are provided on a second main surface of the electrically insulating substrate, opposite the first main surface. Exemplarily, the first rf electrode and the first dc as well as the second rf electrode and the second dc are applied by a physical vapour deposition method, e.g. sputtering, a chemical vapour deposition method and/or an electroplating process.

The electrically insulating substrate is formed or consists of an electrically insulating material. For example, the electrically insulating material comprises or consists of at least one of sapphire, aluminium oxide, as Al₂O₃, aluminium nitride, silicon or diamond or any other suitable material.

According to at least one embodiment of the quantum computing arrangement, the first region comprises a first substrate and the second region comprises a second substrate. For example, in this embodiment, the intermediate layer comprises a spacer layer for the first substrate and the second substrate. The spacer layer can be formed from the same materials described herein above in connection with the intermediate layer being the electrically insulating substrate. Exemplary, the spacer layer does not overlap in lateral directions with the first axis. The spacer layer, for example, does not overlap with the first rf electrodes and the first dc electrodes and the second rf electrodes and the second dc electrodes in lateral directions. For example, the spacer layer can be formed of pillars arranged in edge regions of the first substrate and the second substrate.

Exemplarily, the first substrate is electrically insulating and provides a base for the first rf electrode and the first dc electrode. For example, the first rf electrode and the first dc electrode are provided on an inner main surface of the first substrate. Further, the first rf electrode and the first dc electrode are provided, for example, on an outer main surface of the first substrate.

The inner main surface and the outer main surface of the first substrate are connected by a side surface. Exemplarily, the first rf electrode and the first dc electrode are provided on the side surface of the first substrate.

Exemplarily, the second substrate is electrically insulating and provides a base for the second rf electrode and the second dc electrode. For example, the second rf electrode and the second dc electrode are provided on an inner main surface of the second substrate. Further, the second rf electrode and the second dc electrode are provided, for example, on an outer main surface of the second substrate.

The inner main surface and the outer main surface of the second substrate are connected by a side surface. Exemplarily, the second rf electrode and the second dc electrode are provided on the side surface of the second substrate.

The inner main surface of the first substrate faces the inner main surface of the second substrate. The outer main surface of the first substrate faces away from the outer main surface of the second substrate.

The inner main surface of the first substrate and/or the outer main surface of the first substrate and/or the inner main surface of the second substrate and/or the outer main surface of the second substrate are covered by the respective electrodes to a large extend. A large extend means here that the respective electrodes cover at least 40%, at least 60%, at least 80% or at least 90% of the outer main surface of the first substrate and/or the outer main surface of the second substrate. Advantageously, charging can be avoided particularly well with covering the outer main surfaces to a large extend with the electrodes.

The first substrate and the second substrate are each formed or consists of the electrically insulating material, which comprises or consists exemplarily of at least one of sapphire, aluminium oxide, as Al₂O₃, aluminium nitride, silicon or diamond or any other suitable material.

According to at least one embodiment of the quantum computing arrangement, the at least one permanent magnet arrangement is arranged within the intermediate region. In this case, the main extension plane of the at least one permanent magnet arrangement extends in lateral directions, i.e. parallel to the further main extension plane of the ion trap.

It is possible, if the intermediate region comprises the electrically insulating substrate, the at least one permanent magnet arrangement is embedded in the electrically insulating substrate. “Embedded” means here that at least one outer surface of the at least one permanent magnet arrangement is covered by the electrically insulating substrate. Exemplarily, all outer surfaces of the at least one permanent magnet arrangement are covered by the electrically insulating substrate.

If the quantum computing arrangement comprises more than one permanent magnet arrangement, all permanent magnet arrangements can be arranged within the intermediate region. For example, the permanent magnet arrangements are spaced apart from one another in lateral directions along the first axis. If the quantum computing arrangement comprises more than one section, at least one of the sections, in particular each section or a group of more than one section, is associated with one of the permanent magnet arrangements.

Alternatively, one permanent magnet arrangement surrounds the ion trap and at least one permanent magnet arrangement is within the intermediate region. In both cases, all permanent magnet arrangements can have the same first axis.

In this embodiment it is possible that the first axis is the axisymmetric axis of the permanent magnet arrangement and the trapped ions are located on the axisymmetric axis of the permanent magnet arrangement. In this case, the permanent magnet arrangement is part of the ion trap.

If the quantum computing arrangement comprises more than one permanent magnet arrangement, the permanent magnet arrangement can be configured to provide different magnetic field gradients. Thus, regions having comparatively high magnitudes of the magnetic field and regions having comparatively low magnitudes of the magnetic field can be achieved. Advantageously, due to such different regions, in particular due to regions having comparatively low magnitudes of the magnetic field, an uncritical ion transport can be achieved.

According to at least one embodiment of the quantum computing arrangement, a soft magnetic material forming a yoke structure is arranged within the intermediate region. This is that the soft magnetic material is arranged between the first substrate and the second substrate.

It is possible, if the intermediate region comprises the electrically insulating substrate, the soft magnetic material is embedded in the electrically insulating substrate. “Embedded” means here that at least one outer surface of the soft magnetic material is covered by the electrically insulating substrate. Exemplarily, all outer surfaces of the soft magnetic material are covered by the electrically insulating substrate.

It is possible that the soft magnetic material as well as the permanent magnet arrangement are arranged within the intermediate region. In this case, the soft magnetic material as well as the permanent magnet arrangement are part of the ion trap.

Alternatively, solely the soft magnetic material is arranged within the intermediate region and the permanent magnet arrangement surrounds the ion trap. In this case, solely the soft magnetic material is part of the ion trap.

Alternatively or additionally, it is conceivable that the soft magnetic material is not part of the ion trap. In this case, the soft magnetic material is arranged externally with respect to the ion trap.

Additionally or alternatively, the at least one permanent magnet arrangement is arranged on a main surface of the electrically insulating substrate and/or the soft magnetic material is arranged on a main surface of the electrically insulating substrate.

According to at least one embodiment of the quantum computing arrangement, the at least one permanent magnet arrangement is arranged within the first region and/or within the second region. Exemplarily, the at least one permanent magnet arrangement is embedded in the first substrate and/or the second substrate. Additionally or alternatively, the at least one permanent magnet arrangement is arranged on the inner main surface and/or the outer main surface of the first substrate and/or the at least one permanent magnet arrangement is arranged on the inner main surface and/or the outer main surface of the second substrate.

According to at least one embodiment of the quantum computing arrangement, the soft magnetic material forming a yoke structure is arranged within the first region and/or within the second region. Exemplarily, the soft magnetic material is embedded in the first substrate and/or the second substrate. Additionally or alternatively, the soft magnetic material is arranged on the inner main surface and/or the outer main surface of the first substrate and/or the soft magnetic material is arranged on the inner main surface and/or the outer main surface of the second substrate.

In sum, the yoke structure is placed in regions, where the magnetic field of the permanent magnet arrangement is already of small magnitude and concentrates it to the small cross section of the yoke structure without exceeding the saturation magnetization of the yoke structure, thus substantially boosting the magnitude of achievable magnetic field gradients, allowing for lower cross-talk, stronger couplings and faster quantum gates.

According to another embodiment, the first end cap electrodes and/or the second end cap electrodes can be formed of the soft magnetic material. Exemplarily, the first cap electrodes and/or the second cap electrodes can be formed of the soft magnetic material.

In all cases, the soft magnetic material is, for example, surrounded by the permanent magnet arrangement configured to concentrate the magnetic field established by the permanent magnet arrangement, in particular along the first axis in a region of the ion trap.

According to at least one embodiment of the quantum computing arrangement, the first substrate and the second substrate have a recess extending in vertical direction from the outer main surface of the first substrate to the outer main surface of the second substrate and extending in lateral directions between the first rf electrode and the first dc electrode. Exemplarily, the recess completely penetrates the first substrate and the second substrate in vertical direction. Further, the recess extends in lateral directions between the second rf electrode and the second dc electrode.

For example, a material of the intermediate layer, i.e. a material of the spacer layer or a material of the electrically insulating substrate, is completely penetrated by the recess.

Exemplarily, the ion crystal, i.e. the trapped ions, are located within the recess. This is to say that at least one side surface, delimiting the recess, surrounds the ion crystal, i.e. the trapped ions, in lateral directions, in particular completely. Exemplarily, the first axis is extending in lateral directions within the main extension plane of the intermediate layer.

According to at least one embodiment of the quantum computing arrangement, the at least one permanent magnet arrangement is arranged above the first region and/or below the second region. In this case, the main extension plane of the at least one permanent magnet arrangement extends in lateral directions, i.e. parallel to the further main extension plane of the ion trap.

In this case, the first axis is parallel to the axisymmetric axis of the permanent magnet arrangement, i.e. the first axis has a distance to the axisymmetric axis. The magnitude of the magnetic field has a maximum at positions on the axisymmetric axis of the permanent magnet arrangement. In this case, the magnetic field is, exemplarily, the magnetic quadrupole field.

Exemplarily, the permanent magnet arrangement establishes a magnetic field which is mainly concentrated in a magnetic field plane, mainly extending along the main extension plane. The magnitude of the magnetic field decays in radial direction of the axisymmetric axis, being for example perpendicular to the magnetic field plane. This is to say that the magnitude of the magnetic field is nonzero within a distance of the axisymmetric axis, e.g. along the first axis.

Exemplarily, the magnetic field decays in radial direction dependent on at least one dimension of the permanent magnet arrangement. The dimension can comprise at least one of a radius and/or a thickness. For example, the decay length increases with the radius, in particular an inner radius and/or an outer radius of the permanent magnet arrangement. Further, the decay length increases with the thickness, perpendicular to the magnetic field plane, of the permanent magnet arrangement.

For example, the magnitude of the magnetic field has a Full Width Half Maximum (FWHM) of at least 1 μm or at least 10 μm and at most 10 mm or at most 500 μm in radial direction of the axisymmetric axis, being perpendicular to the magnetic field plane. Thus, even if the first axis has a distance to the axisymmetric axis, the magnitude of the magnetic field is still present on the first axis.

Exemplarily, the at least one permanent magnet arrangement has a distance in vertical direction to the first region and/or the second region of at most 500 μm or at most 100 μm.

According to at least one embodiment of the quantum computing arrangement, the ion trap comprises a plurality of the sections, and each section is configured to host one ion crystal. The ion crystals are arranged along the first axis.

According to at least one embodiment of the quantum computing arrangement, the ion crystals are configured to interact with one another by ion transport and/or photonic links.

If the ion crystals are configured to interact with one another by ion transport, an interaction, in particular the coupling of different ion crystals, is configured by the first separating cap electrodes and the second separating cap electrodes, being arranged between two directly neighbouring sections, described herein above.

If the ion crystals are configured to interact with one another by photonic links, the interaction, in particular the coupling of different ion crystals, is configured by a probabilistic photonic interface between the ion crystals. Advantageously, the photonic link between at least two ion crystals can be provided also for comparatively long distances between these ion crystals.

According to at least one embodiment of the quantum computing arrangement, the permanent magnet arrangement comprises a plurality of segments, namely at least four segments. For example the permanent magnet arrangement comprises at least four segments, in particular at least 8 segments, at least 16 or at least 32 segments. Each segment comprises a permanent magnetic material. In particular, each of the segments comprises the same permanent magnetic material. Exemplarily, the permanent magnetic material comprises a ferromagnetic material.

Each segment is formed, for example, in one piece. Alternatively, each segment is formed from at least two sub-segments, wherein the at least two sub-segments have the same material and/or magnetisation properties.

The first axis extends in a preferred embodiment linearly from one of the segments to another of the segments being located directly opposite to said one of the segments with respect to a centre of the permanent magnet arrangement. These two segments are displaced along the first axis.

According to at least one embodiment of the quantum computing arrangement, each segment has a magnetisation direction. A magnetisation of each segment is defined by a vector field being representative of dipole moments of the respective permanent magnetic material. This is to say that the respective permanent magnetic material exhibits dipole moments. This is that the permanent magnetic material is magnetized, such that in the absence of external magnetic fields, a magnetic field can be measured in the vicinity of the permanent magnetic material. The vector field, in particular the dipole moments of the permanent magnetic material, define the respective magnetisation direction. The dipole moments largely point in the magnetisation direction.

According to at least one embodiment of the quantum computing arrangement, the magnetisation directions of segments being arranged at opposite regions are directed in opposite directions. The segments are arranged with respect to the centre of the permanent magnet arrangement at opposite regions. The magnetisation directions of segments being arranged at opposite regions are diametrical to one another.

In particular, the first axis, in particular the axisymmetric axis, is defined with respect to two segments being arranged opposite to each another, wherein the magnetisation directions of the respective two segments are parallel to the first axis, in particular the axisymmetric axis.

If there are m segments, wherein m is an even natural number of at least 4, the magnetisation directions of the two directly neighbouring segments are rotated by 360°·3/m with respect to one another.

Exemplary, the permanent magnet arrangement is a Halbach arrangement.

Particularly, the magnitudes of the magnetic field in the centre region being established by the permanent magnet arrangement change by at least 0.5 T/m and at most 500 T/m. In particular, the magnitudes of the magnetic field in the centre region change by at least 50 T/m and at most 250 T/m, exemplarily 150 T/m.

According to at least one embodiment, the quantum computing arrangement further comprises at least one additional permanent magnet arrangement. In particular, the quantum computing arrangement can comprise several additional permanent magnet arrangements. The additional permanent magnet arrangement can have the same dimensions and/or properties as the permanent magnet arrangement described herein above.

According to at least one embodiment of the quantum computing arrangement, the permanent magnet arrangement has a rotated position relative to the additional permanent magnet arrangement.

For example, the additional permanent magnet arrangement is arranged with respect to the permanent magnet arrangement in a rotated form, in particular an out of plane rotated form, such that an angle is enclosed by the respective main extension planes. This is that the additional main extension plane of the additional permanent magnet arrangement is rotated out of the plane of the main extension plane of the permanent magnet arrangement. Exemplary, the angle can be between 0° and 90°.

For example, the additional permanent magnet arrangement is rotated by 90° with respect to the permanent magnet arrangement, such that the respective main extension planes enclose an angle of 90°. In this embodiment, the first axis and an additional first axis corresponding to the additional permanent magnet arrangement are positioned perpendicular to one another.

According to at least one embodiment of the quantum computing arrangement, the permanent magnet arrangement and the additional permanent magnet arrangement are parallel to each other.

Exemplarily, the first axis and the additional first axis are positioned parallel to one another.

Alternatively, the additional permanent magnet arrangement is arranged with respect to the permanent magnet arrangement in a rotated form, in particular an in plane rotated form. In this case, the main extension plane and the additional main extension plane are parallel to one another. For such an in plane rotation, an angle is enclosed by the respective first axis, i.e. the first axis and the additional first axis. Exemplary, the angle can be between 0° and 90°.

For example, the additional permanent magnet arrangement is rotated in plane by 90° with respect to the permanent magnet arrangement, such that the respective first axis enclose an angle of 90°. In this embodiment, the first axis and the additional first axis are positioned perpendicular to one another.

Such arrangements comprising the permanent magnet arrangement and the additional permanent magnet arrangement exemplarily each forms—in terms of the magnetic field—a three dimensional confined space, e.g. a three dimensional gradient space.

Additionally, a quantum computer is specified wherein the quantum computer comprises a quantum computing arrangement as described herein above. This is to say that the features concerning the quantum computer are also applicable for the quantum computing arrangement and vice versa.

The quantum computer is configured to perform quantum computing processes by using the quantum computing arrangement. The trapped ions of the quantum computing arrangement can be controlled and manipulated particularly well with the permanent magnet arrangement described herein above, in order to perform predetermined quantum calculations.

### BRIEF DESCRIPTION OF THE DRAWINGS

In the following, the quantum computing arrangement is explained in more detail with reference to exemplary embodiments and the associated Figures.

FIGS. 1 and 2 each show a quantum computing arrangement according to an exemplary embodiment;

FIG. 3 shows a quantum computing arrangement according to an exemplary embodiment;

FIGS. 4 and 5 each show a cross-sectional view of a quantum computing arrangement according to an exemplary embodiment;

FIG. 6 shows a top view of an ion trap of a quantum computing arrangement according to an exemplary embodiment; and

FIG. 7 shows a quantum computer according to an exemplary embodiment.

Elements that are identical, similar or have the same effect are given the same reference signs in the Figures. The Figures and the proportions of the elements shown in the figures are not to be regarded as true to scale. Rather, individual elements may be shown exaggeratedly large for better representability and/or for better comprehensibility.

### DETAILED DESCRIPTION OF ILLUSTRATIVE EMBODIMENTS

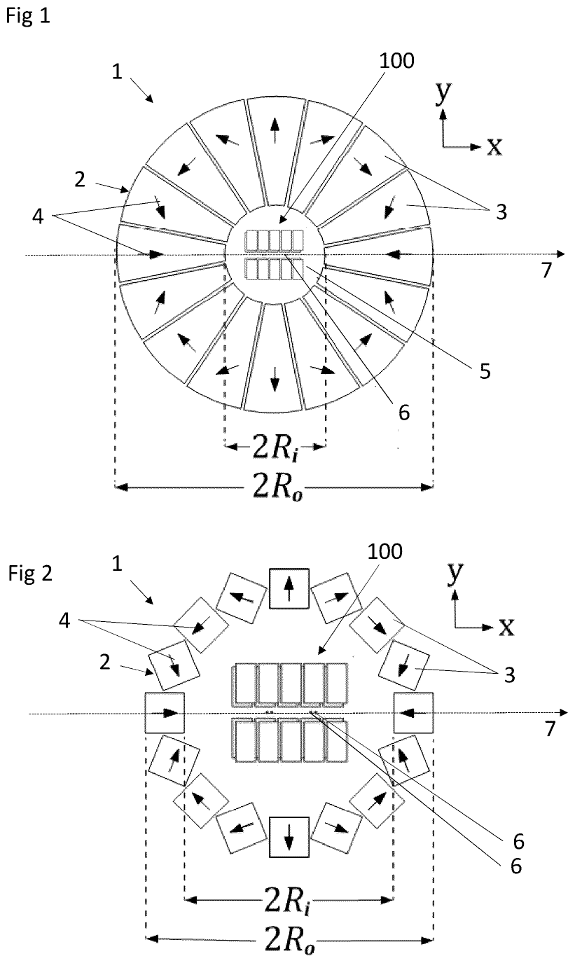

A quantum computing arrangement 1 according to the exemplary embodiment of FIG. 1 comprises a permanent magnet arrangement 2. The permanent magnet arrangement 2 comprises 16 segments 3. The segments 3 surround a space 5 of the quantum computing arrangement 1, where trapped ions 6 are trapped during operation of the quantum computing arrangement 1. The segments 3 surround the space 5 in the form of a ring. Each segment 3 is arranged with its centre on a point of the ring.

The permanent magnet arrangement 2 has a main extension plane extending along the x-axis and y-axis shown in FIG. 1. Each segment 3 has a cross-sectional form of an annulus sector or circular ring sector, wherein all segments share the same common inner ring and same common outer ring. In particular, a width of each segment 3 tapers down towards the space 5. This is that opposing edges of each segment 3 facing the space 5 are curved. A normal bundle of the curved edges points away from the space 5. This is to say that a radius of the curved edges are defined with respect to a centre region of the permanent magnet arrangement 2.

The curved edges of segments 3 being arranged at opposite regions with respect to the centre region and facing one another have a minimal distance from one another of at least 0.001 cm and at most 100 cm. In particular, the minimal distance is at least 0.01 cm or at least 1 cm and at most 25 cm or at most 50 cm, for example, approximately 10 cm according to the exemplary embodiment of FIG. 1. The minimal distance divided by two defines an inner radius Ri of the permanent magnet arrangement 2.

Furthermore, each segment 3 has an extent along the corresponding minimal distance being at least 0.001 cm and at most 100 cm, in particular at least 0.01 cm or at least 1 cm and at most 25 cm or at most 50 cm, for example, approximately 20 cm according to the exemplary embodiment of FIG. 1. The minimal distance divided by two and the extent along the corresponding minimal distance defines an outer radius Ro of the permanent magnet arrangement 2.

For example, directly neighbouring segments 3 are spaced apart from one another. Edges of directly neighbouring segments 3 facing one another have a distance to one another of approximately 1 mm.

In this exemplary embodiment, each segment 3 has a line of symmetry, bisecting opposite edges facing the space 5. The line of symmetry is the same for segments 3 being arranged opposite to one another. One of the lines of symmetry represents a first axis 7 of the permanent magnet arrangement 2, wherein the first axis 7 exemplarily extends within the main extension plane. In this exemplary embodiment, the first axis 7 is an axisymmetric axis 7′ of the permanent magnetic arrangement.

Furthermore, each segment 3 has a magnetisation direction 4 being depicted as arrows within the segments 3 in FIG. 1. The magnetisation directions 4 of segments 3 being arranged at opposite regions with respect to a centre of the permanent magnet arrangement 2 are directed in opposite directions. The first axis 7 of the permanent magnet arrangement 2 is defined with respect to two segments 3 being arranged opposite to one another, wherein the magnetisation directions 4 of the respective two segments 3 are parallel to the first axis 7.

Each magnetisation directions 4 encloses an angle with the first axis 7. All of these angles are formed differently. For example, the angles of directly neighbouring segments 3 differ by 67.5° from one another, if the permanent magnet arrangement 2 comprises 16 segments 3.

In the exemplary embodiments of the FIGS. 1 and 2, the first axis 7 points in the direction of the x-axis.

Furthermore, the angle of the segment 3, having a magnetisation direction 4 being parallel to the first axis 7 and pointing in the same direction as the first axis 7 is 00. The angle of the opposite segment 3 having a magnetisation direction 4 being parallel to the first axis 7 and pointing in the opposite direction as the first axis 7 is 180°.

Going on the ring clockwise from the segment 3 having a magnetisation direction 4 being parallel to the first axis 7 and pointing in the same direction as the first axis 7 back to this segment 3, the magnetisation direction 4 also rotates clockwise.

With such segments 3, the permanent magnet arrangement 2 is configured to produce a quadrupole field and thus has different magnitudes at different positions along the first axis 7, i.e. a magnetic field gradient along the first axis 7. Further, during operation of the quantum computing arrangement 1 the trapped ions 6 are arranged linearly next to one another along the first axis 7.

The quantum computing arrangement 1 comprises an ion trap 100 for trapping trapped ions 6. The ion trap 100 has a further main extension plane extending along the x-axis and y-axis shown in FIG. 1. This is to say that the main extension plane of the permanent magnet arrangement 2 and the further main extension plane of the ion trap 100 are parallel to one another, in particular extending in the same plane.

It is conceivable that the further main extension plane is rotated with respect to the main extension plane, i.e. the further main extension plane can be oriented along every radial direction of the first axis 7.

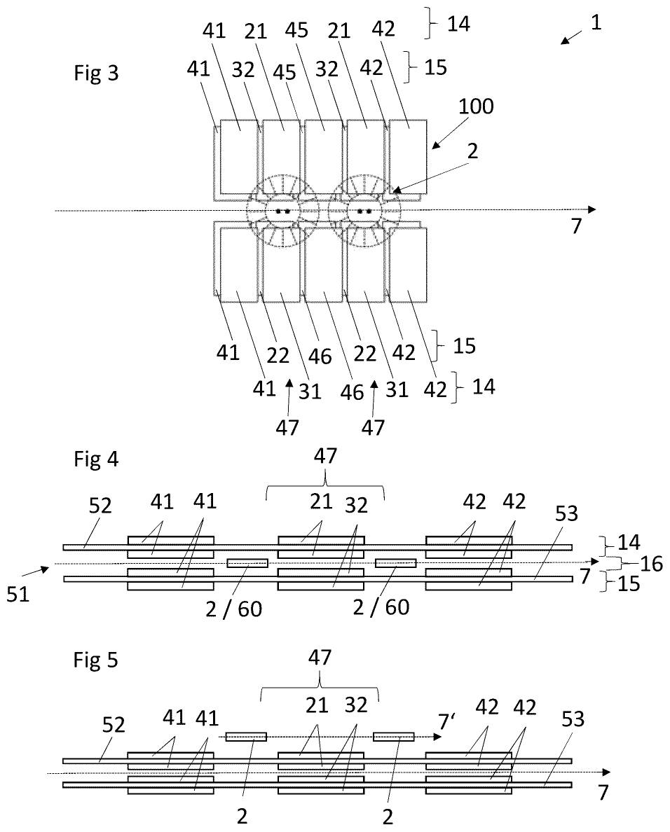

The ion trap 100 has a first region 14 and a second region 15 arranged above one another, being shown, for example, in connection to FIGS. 3 and 4. For better representability, the reference signs concerning the ion trap 100 are shown in detail in connection to FIGS. 3 and 4. In this exemplary embodiment, the first region 14 and the second region 15 each extend parallel to the further main extension plane. The first region 14 comprises first end cap electrodes 41, second end cap electrodes 42, first rf electrodes 21 and first dc electrodes 31. Further, the second region 15 comprises first end cap electrodes 41, second end cap electrodes 42, second rf electrodes 22 and second dc electrodes 32. Exactly one of the first dc electrodes 31, exactly one of the first rf electrode 21, exactly one of the second dc electrodes 32 and exactly one of the second rf electrodes 22 form a section 47.

The first end cap electrode 41, comprising two parts, of the first region 14 is arranged in a first end region of the ion trap 100 and the second end cap electrode 42, comprising two parts of the first region 14 is arranged in a second end region of the ion trap 100, between which the sections 47 are located. Further, the first end cap electrode 41, comprising two further parts, of the second region 15 is arranged in the first end region of the ion trap 100 and the second end cap electrode 42, comprising two further parts of the second region 15 is arranged in the second end region of the ion trap 100, between which the sections 47 are located.

The two parts of the first end cap electrode 41 of the first region 14 and the two further parts of the first end cap electrode 41 in the second region 15 are completely overlapping in top view, in particular congruently. The two parts of the second end cap electrode 42 of the first region 14 and the two further parts of the second end cap electrode 42 in the second region 15 are completely overlapping in top view, in particular congruently.

The sections 47 are arranged between the first end cap electrodes 41 and the second end cap electrodes 42 along the first axis 7. Between directly neighbouring sections 47, a first separating cap electrode 45 and second separating cap electrode 46 are arranged in each of the first region 14 and the second region 15.

The first separating cap electrode 45 comprises two parts, wherein one part is arranged in the first region 14 and the other part is arranged in the second region 15. The two parts are completely overlapping in top view, in particular congruently.

Furthermore, the second separating cap electrode 46 comprises two parts, wherein one part is arranged in the first region 14 and the other part is arranged in the second region 15. The two parts are completely overlapping in top view, in particular congruently. The first separating cap electrode 45 and the second separating cap electrode 46 are arranged opposite one another with respect to the first axis 7.

It is further conceivable that the first separating cap electrode 45 is configured to be supplied with a rf current and the second separating cap electrodes 46 is configured to be supplied with a dc current. In this case the first separating cap electrodes 45 and the second separating cap electrodes 46 of the first region 14 and the second region 15 are formed as the first rf electrode 21, the first dc electrode 31, the second rf electrode 22 and the second dc electrode 32 and thereby form one of the sections 47.

The first rf electrode 21 of one section 47 is arranged above the second dc electrode 32 of the same section 47. The first dc electrode 31 of the same section 47 is arranged above the second rf electrode 22 of the same section 47. The electrodes arranged above one another completely overlap in top view, in particular congruently.

The two parts of the first end cap electrode 41 of the first region 14 are spaced apart from one another by a first distance in lateral directions perpendicular to the first axis 7. The first rf electrode 21 as well as the first dc electrodes 31 of the sections 47 are spaced apart from one another by the first distance in lateral directions perpendicular to the first axis 7. The first separating cap electrode 45 as well as the second separating cap electrodes 46 are spaced apart from one another by the first distance in lateral directions perpendicular to the first axis 7.

Analogously, the electrodes of the second region 15 are spaced apart from one another by the first distance in lateral directions perpendicular to the first axis 7.

Furthermore, directly neighbouring electrodes have a second distance to one another in lateral directions parallel to the first axis 7. The second distances can be equal to one another. Each second distance is smaller than the first distance.

The first end cap electrodes 41 and the second end cap electrodes 42 as well as the first separating cap electrodes 45 and the second separating cap electrodes 46 are configured to trap the to-be-trapped ions 6 along the first axis 7 via an applied dc current.

The first rf electrode 21, the first dc electrode 31, the second rf electrode 22 and the second dc electrode 32 are configured to trap the to-be-trapped ions 6 in radial direction with respect to the first axis 7 via applied rf and dc currents.

Each section 47 is configured to trap, with the applied currents, exactly one ion crystal. Each ion crystal comprises a plurality of trapped ions 6 arranged along to the first axis 7.

The ion crystals, i.e. the trapped ions 6, are arranged along the first axis 7, wherein the first axis 7 is arranged between the electrodes in vertical direction as well as between the electrodes in lateral directions. This is to say that the ion crystals, i.e. the trapped ions 6, are provided in vertical direction between the first region 14 and the second region 15 and in lateral direction between the rf electrode and the dc electrode of the first region 14 and the second region 15.

For example, the inner radius Ri according to the exemplary embodiment of FIG. 3 is approximately 100 μm and the outer radius Ro is approximately 300 μm. Exemplarily, the inner radius Ri according to the exemplary embodiment of FIG. 2 is approximately 5 cm and the outer radius Ro is approximately 25 cm.

The remanence B_{R} of each of the segments 3 is, for example, 1 T. Thus, the magnetic field, in particular the corresponding magnetic flux density \vec{B} can be calculated by:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) .$$

An origin of the coordinates x and y is located at the centre of the permanent magnet arrangement 2.

Furthermore, distances d of directly neighbouring trapped ions 6 are approximately 3 to 10 μm. Thus, the magnetic flux density g can be calculated for each position of the trapped ions 6. Consequently, also the difference for specific transitions between neighbouring trapped ions 6 can be determined.

Exemplarily, a frequency difference of σ±-transitions between directly neighbouring trapped ions 6 is at least 10 kHz and at most 100 MHz. σ±-transitions can be excited by a left- or right-circularly polarised electromagnetic wave with a polarization perpendicular to the local magnetic field.

For example, a frequency difference of n-transitions between directly neighbouring trapped ions 6 is at least 1 kHz and at most 10 MHz. Such a n-transition is excited by a linearly polarised electromagnetic wave with a polarization parallel to the local magnetic field.

In contrast to the exemplary embodiment of FIG. 1, the quantum computing arrangement 1 according to the exemplary embodiment of FIG. 2 comprises a permanent magnet arrangement 2 having segments 3, each having a squared form.

Each segment 3 has a cross-sectional form of a square. The magnetisation directions 4 with respect to the edges of the squares are the same for each segment 3. Directly neighbouring segments 3 are rotated with respect to one another, such that the magnetisation directions 4 of each segment 3 correspond to the angles according to FIG. 1.

The permanent magnetic arrangement of the quantum computing arrangement 1 according to the exemplary embodiment of FIG. 3 does not surround the ion trap 100, in contrast to the exemplary embodiments of FIGS. 1 and 2. The quantum computing arrangement 1 comprises two permanent magnetic arrangements, wherein each of the permanent magnetic arrangements surrounds an ion crystal. This is to say that each section 47 is provided with a permanent magnetic arrangement.

In this embodiment the first axis 7 is an axisymmetric axis 7′ of each permanent magnetic arrangement, extending along a common axis.

The magnetic field gradients generated by each permanent magnetic arrangement act on the ion crystals of each of the sections 47. Between the sections 47, i.e. in the region of a first separating cap electrode 45 and a second separating cap electrode 46, the magnetic field has a comparatively low magnitude.

The permanent magnetic arrangement of the quantum computing arrangement 1 according to the exemplary embodiment of FIG. 4 has an intermediate region 16 being arranged between the first region 14 and the second region 15. The first region 14 comprises a first substrate 52 for the first dc electrode 31 and the first rf electrode 21 as well as for the first end cap electrode 41 and the second end cap electrode 42. The second region 14 comprises a second substrate 53 for the second dc electrode 32 and the second rf electrode 22 as well as for the first end cap electrode 41 and the second end cap electrode 42. For example, the first rf electrode and the first dc electrode are provided on an inner main surface of the first substrate. The respective electrodes 41, 21, 32, 22, 31, 42 are arranged on an outer main surface and an inner main surface the respective substrates 52, 53. The inner main surface of the first substrate 52 faces the inner main surface of the second substrate 53.

The intermediate region 16 is configured to space apart the first substrate 52 and the second substrate 53 in vertical direction. The intermediate region 16 comprises exemplarily a spacer layer 51.

The intermediate region 16 can comprise the permanent magnetic arrangements according to FIG. 3.

Alternatively, a soft magnetic material forming a yoke structure 6o is arranged between the first substrate 52 and the second substrate 53 within the intermediate region 16. In this case, the permanent magnetic arrangement is formed as shown in one of the FIG. 1 or 2. The soft magnetic material is configured to enhance a difference in the magnitude of the magnetic field in the region of the soft magnetic material and thus enhances the magnetic field gradient along the first axis 7 for each section 47.

Contrary to the exemplary embodiment of FIG. 4, the permanent magnetic arrangements according to the exemplary embodiment of FIG. 5 is arranged above the ion trap 100. The permanent magnetic arrangements each have an axisymmetric axis 7′ being spaced apart from the first axis 7 on which the trapped ions 6 are located.

The magnitude of the magnetic field of each permanent magnetic arrangement has a maximum on the axisymmetric axis 7′. The magnitude of the magnetic field decays in radial direction of the axisymmetric axis 7′ such that the magnitude of the magnetic field is non zero along the first axis 7. In particular, the largest magnitude of the magnetic field along the axis 7 is located directly below the permanent magnetic arrangement 2 in top view.

In this embodiment it is conceivable that a soft magnetic material, as described in connection with the exemplary embodiment of FIGS. 4, is arranged within the intermediate region 16.

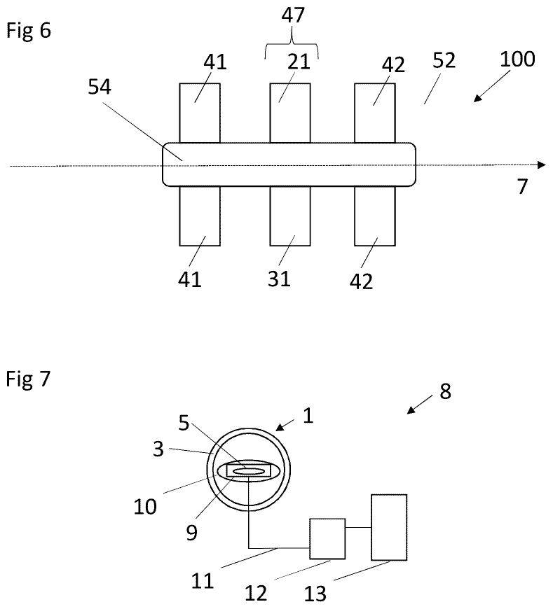

The ion trap 100 of the quantum computing arrangement 1 according to the exemplary embodiment of FIG. 6 comprises an intermediate region 16 according to the exemplary embodiments of FIGS. 4 and 5. The first substrate 52 as well as the second substrate 53 have a recess 54, extending completely through the first substrate 52 and the second substrate 53.

The first dc electrode 31 and the first rf electrode 21 as well as the first end cap electrode 41 and the second end cap electrode 42 are also arranged on a side surface of the first substrate 52 defined by the recess 54. In this context, the second dc electrode 32 and the second rf electrode 22 as well as the first end cap electrode 41 and the second end cap electrode 42 are also arranged on a side surface of the second substrate 53 defined by the recess 54. Therefore, electrodes 21, 22, 31, 32, 41, 42, 45, 46 are be arranged on the side surfaces of the first substrate and the second substrate delimiting the recess 54.

The intermediate region 16 can also have the recess 54 extending in vertical direction from the first region 14 to the second region 15 and extending in lateral directions between the first rf electrode 21 and the first dc electrode 31 as well as between the second rf electrode 22 and the second dc electrode 32. In operation, an ion crystal, i.e. trapped ions 6, are located within the recess 54 within the intermediate region 16.

A quantum computer 8 according to the exemplary embodiment of FIG. 7 comprises a quantum computing arrangement 1 according to one of the exemplary embodiments of FIGS. 1, 2 or 3 as well as a quantum computing device 9 located within a chamber 10. The quantum computing device 9 is connected to external components of the quantum computer 8 through the chamber 10 by a plurality of connections 11. For example, the connections 11 connect the quantum computing device 9 with external electronic 12 and a classical computer 13.

For example, the quantum computing device 9 is an ion trap 100 configured to trap, manipulate and measure trapped ions, each being a qubit, within a space 5 during operation. For this, the quantum computing device 9 can comprise electrodes, light guides and/or internal electronics comprising electronic devices. The electronic devices can comprise circuitry, integrated electronic, and/or detectors, such as photon detectors and/or charge detectors, controllers. Exemplarily, the internal electronics are provided for pre-processing. For example, these components allow a measurement of a respective state of the qubits and allow gate operations on the qubits. Thus, the quantum computing device 9 is configured to trap the trapped ions as well as to carry out operations and measurements on the trapped ions.

The quantum computing device 9 is mounted in the chamber 10, wherein the chamber 10 can be an ultra-high vacuum chamber, an extreme-high vacuum chamber and/or a cryostat. If the chamber 10 is an ultra-high vacuum chamber or an extreme-high vacuum chamber, it is possible that the permanent magnet arrangement 2 is arranged outside the chamber 10. In this case the permanent magnet arrangement 2 surrounds the chamber 10. Alternatively, it is also possible to arrange the permanent magnet arrangement 2 within an ultra-high vacuum chamber or an extreme-high vacuum chamber or a cryostat.

Exemplarily, if the chamber 10 is a cryostat, the permanent magnet arrangement 2 is arranged inside the chamber 10 (not shown here). It is also conceivable that if the chamber 10 is a cryostat, the permanent magnet arrangement 2 can be arranged also outside the chamber 10 (not shown here).

The quantum computing device 9 is connected to the external electronic 12 via the connections 11. The external electronic 12 can be located at least partially inside and partially outside the chamber 10. Further, the external electronic 12 is connected to the classical computer 13.

The external electronic 12 comprises, exemplarily, analog to digital converters as well as signal generators such as radio frequency generators, microwave signal generators, low-frequency signal generators and/or direct current signal generators. Furthermore, the external electronic 12 can comprise a transistor-transistor logic, TTL.

Additionally, the external electronic 12 can further comprise at least one laser system configured to cool the to-be-trapped ions 6. Further, the laser system can be configured to excite a particular state of the trapped ions 6.

The classical computer 13 is configured, for example, to provide and receive digital signals. The digital signals correspond to control signals used for operations on the qubits as well as to measurement signals corresponding to a state of the qubits.

The external electronic 12 is, inter alia, configured to convert the digital signals to analog signals and vice versa. Therefore, the external electronic 12 is configured to provide the converted analog signals for manipulating the qubits to the quantum computing device 9. Further, the external electronic 12 is configured to provide measured analog signals from the quantum computing device 9 to the classical computer 13 or to process such signals to directly initiate some response signal generated by the control electronics 12.

The classical computer 13 is exemplarily configured to be provided with a specific algorithm, i.e. a predetermined quantum calculation solving a specific problem. The classical computer 13 is then configured to convert a compiled code corresponding to the algorithm to commands for the quantum computing device 9. The commands are subsequently forwarded via the external electronic 12 to the quantum computing device 9. Furthermore, the classical computer 13 is configured to receive a measured outcome of the specific algorithm.

For example, all elements of the quantum computer 8, in particular all electronic elements of the quantum computer 8, are synchronized by an atomic clock reference, for example.

The invention is not limited to the exemplary embodiments by their description. Rather, the invention encompasses any new feature as well as any combination of features, which in particular includes any combination of features in the claims, even if this feature or combination itself is not explicitly indicated in the claims or exemplary embodiments.

1.-20. (canceled)

21. A quantum computing arrangement comprising:
a permanent magnet arrangement configured to establish a magnetic field with magnitudes being different from one another for different positions on a first axis; and
an ion trap having a first region and a second region arranged above one another,
wherein the ion trap has at least one section being part of the first region and the second region configured for hosting at least one ion crystal,
wherein the first and second regions are stacked above one another in a vertical direction, wherein the vertical direction is perpendicular to a main extension plane of the ion trap,
wherein the at least one ion crystal comprises a plurality of trapped ions arranged along the first axis, and
wherein the at least one section comprises:
a first radio frequency (RF) electrode and a first direct current (DC) electrode in the first region, and
a second RF electrode and a second DC electrode in the second region.

22. The quantum computing arrangement according to claim 21, wherein each of the first region or the second region comprises at least two cap electrodes arranged at respective end regions of the first region and the second region.

23. The quantum computing arrangement according to claim 21,
wherein the first RF electrode and the first DC electrode are spaced apart from one another perpendicular to the first axis,
wherein the second RF electrode and the second DC electrode are spaced apart from one another perpendicular to the first axis,
wherein the first RF electrode is arranged above the second DC electrode, and
wherein the first DC electrode is arranged above the second RF electrode.

24. The quantum computing arrangement according to claim 21, wherein each of the first DC electrode, the second DC electrode, the first RF electrode or the second RF electrode comprises a metallic film.

25. The quantum computing arrangement according to claim 24, wherein the metallic film has a thickness of at most 30 μm.

26. The quantum computing arrangement according to claim 21, further comprising an intermediate region between the first region and the second region.

27. The quantum computing arrangement according to claim 26, wherein the intermediate region comprises an electrically insulating substrate for the first DC electrode, the second DC electrode, the first RF electrode and the second RF electrode.

28. The quantum computing arrangement according to claim 21,
wherein the first region comprises a first substrate, and
wherein the second region comprises a second substrate.

29. The quantum computing arrangement according to claim 26,
wherein the permanent magnet arrangement is arranged within the intermediate region, and/or
wherein a soft magnetic material forming a yoke structure is arranged within the intermediate region, or
wherein the permanent magnet arrangement is arranged within the first region and/or within the second region, and/or
wherein the soft magnetic material forming a yoke structure is arranged within the first region and/or within the second region.

30. The quantum computing arrangement according to claim 28, wherein the first substrate and the second substrate have a recess extending in a vertical direction from an outer main surface of the first substrate to an outer main surface of the second substrate and extending in lateral directions between the first RF electrode and the first DC electrode.

31. The quantum computing arrangement according to claim 21, wherein the permanent magnet arrangement is arranged above the first region and/or below the second region.

32. The quantum computing arrangement according to claim 21,
wherein the ion trap comprises a plurality of the sections,
wherein each section is configured to host one ion crystal, and
wherein the ion crystals are arranged along to the first axis.

33. The quantum computing arrangement according to claim 32, wherein the ion crystals are configured to interact with one another by ion transport and/or photonic links.

34. The quantum computing arrangement according to claim 21,
wherein the permanent magnet arrangement comprises a plurality of segments, and
wherein each segment has a magnetisation direction.

35. The quantum computing arrangement according to claim 34, wherein the magnetisation directions of two of the segments arranged opposite to one another are parallel to the first axis.

36. The quantum computing arrangement according to claim 34, wherein the magnetisation directions of segments being arranged at opposite regions are directed in opposite directions.

37. The quantum computing arrangement according to claim 21, wherein the permanent magnet arrangement is a Halbach arrangement.

38. The quantum computing arrangement, according to claim 21, further comprising:
at least one additional permanent magnet arrangement,
wherein the permanent magnet arrangement has a rotated position relative to the additional permanent magnet arrangement, or
wherein the permanent magnet arrangement and the additional permanent magnet arrangement are parallel to each other.

39. A quantum computer comprising:
the quantum computing arrangement according to claim 21,
wherein the quantum computing arrangement is configured for performing quantum computations.
